(19) United States
(12) Patent Application Publication
(10) Pub. No.: US 2006/0229897 A1
(43) Pub. Date: Oct. 12, 2006

(54) Method of facilitating social communication

(76) Inventor: Mike Dwyer, Oxnard, CA (US)

Correspondence Address: TOPE-MCKAY & ASSOCIATES, 23852 PACIFIC COAST HIGHWAY #311, MALIBU, CA, 90265, US

(21) Appl. No.: 11/104,980

(22) Filed: Apr. 12, 2005

(51) Int. Cl. G06Q 99/00

(52) U.S. Cl. 705/1

(57) ABSTRACT

A method of facilitating social communication from a person to a recipient is presented. Initially, a social communication device with a message is selected by the person. The person then attaches the social communication with the delivery device for delivery to the recipient, thus facilitating social communication between the person and the recipient. The message may be pre-existing, randomly generated, or customizable. When the message is customizable, the person customizes the message. The social communication device and the delivery device may be obtained from vendors such as persons, machines, displays, and dispensing racks. The social communication device may be in the form of a sticker with a message and the delivery device may be a beverage container, thus facilitating communication in clubs or public houses.

### BACKGROUND

(1) Field of the Invention

The present invention relates to facilitating communication between people in a social setting, and more specifically to techniques for facilitating communication between people in a social setting utilizing a messaging device which may be delivered to the recipient of the communication.

(2) Description of Related Art

Many people feel intimidated when initiating face-to-face social communication with others (particularly with strangers). In fact, most people suffer from some level of social anxiety even in relaxed social settings. Regardless of whether the people are familiar with each other, there exists a need for an invention which would make initial and continued communication between the two people easier.

Traditional methods of social communication include email, letters, phone calls, online dating services, and face-to-face encounters. However, each of these methods has drawbacks. Email and letters require time to write, send, and respond to, which can be impractical in real-time social situations. Phone calls and face-to-face conversation require that an individual possess a degree of social bravery. Online dating services do not produce real-time results.

One major drawback to conventional communication is the fear of awkwardness or rejection. Unfortunately, these fears often prevent an individual from initiating social communication with another person with whom they would like to be acquainted. Further, nervousness, anxiety, and other factors may prevent individuals from initiating conversation. These problems are present in current social settings and have not been alleviated by the prior art.

Current solutions to the problem of initiating contact include personal matchmaking websites and services. These solutions neither facilitate real-time, face-to-face interaction, nor do they allow the initiator to see the recipient's response. In short, they act as a means of communication in which the participants are isolated from each other, as opposed to facilitating more direct human-to-human interaction, as the present invention does. Also, subscribing to a dating service is a substantial decision that requires additional time and money. Further, doing so may lead to social stigmatization and shame; and, since it may occur in a vacuum of the Internet, it does not allow friends or family members to participate in the social communication between new acquaintances.

None of the prior methods allow a person, who would not otherwise be inclined to speak to another person, to send a message and observe that other person's immediate reaction. This invention seeks to overcome these barriers and challenges present in today's social and dating settings.

Therefore, it would be desirable to provide a method of facilitating social communication between people by allowing people to exchange messages from a distance and view real-time results.

### SUMMARY

The present invention teaches a method of facilitating social communication from a person to a recipient. In one aspect, the method comprises an act of obtaining a social communication device having at least one message. Next, a delivery device is selected. Subsequently, an act is performed for attaching the social communication device with the delivery device; and delivering the delivery device to the recipient. Thus, social communication is facilitated between people.

In another aspect, the message is selected by the person, from a group consisting of a pre-existing message, a randomly generated message, and a customizable message. When the message is customizable, an act of customizing the message is performed.

In still another aspect, the act of obtaining the social communication device is obtained from a vendor.

In a further aspect, the vendor is selected from a group consisting of a person, a vending machine, the Internet, a display, a computer, and a dispensing rack.

In still another aspect, the act of selecting a delivery device is obtained from a delivery device source.

In yet another aspect, the delivery device is selected from a group consisting of a person, a machine, the Internet, a display, and a store.

In a still further aspect, the act of attaching is performed with a mechanism selected from a group consisting of a detachable attachment and a permanent adhesive.

In another aspect, the detachable attachment is selected from a group consisting of an adhesive and a hanging attachment.

In a further aspect, the delivery device is delivered to the recipient by a deliverer.

In yet another aspect, the deliverer is selected from a group consisting of the person, an agent/representative, and a machine.

In a still further aspect, the social communication device is selected from a group consisting of a label, a tag, a sculpture, a machine, a figure, a card, and an object.

In another aspect, the message is selected from a group consisting of a written message, an auditory message, a visual message, a scented message, and a flavored message.

In a yet further aspect, the delivery device is selected from a group consisting of a smoking device, a drinking device, a contraceptive, a gelatin shot, and a food container.

In still another aspect, the drinking device is selected from a group consisting of a bottle, a glass, and a novelty shot glass.

In yet another aspect, the method of facilitating social communication between a person and a recipient in a public establishment comprises:
obtaining a social communication device from the public establishment, where the social communication device has at least one message;
ordering a food/beverage item from the public establishment, where the food/beverage item acts as a delivery device;
attaching the social communication device with the delivery device; and delivering the delivery device to the recipient; and
whereby, social communication is facilitated between people.

In another aspect, the
the message is selected by the person, from a group consisting of a pre-existing message, a randomly generated message, and a customizable message and when:
the message includes a customizable message, customizing the message.

In still another aspect, the social communication device is obtained from a server acting on behalf of the public establishment.

In a further aspect, the public establishment is selected from a group consisting of a bar, a restaurant, and a nightclub.

In a yet further aspect, a delivery device is obtained from a delivery device source.

In a still further aspect, the act of attaching is performed with a mechanism selected from a group consisting of a detachable attachment and a permanent adhesive.

In another aspect, the detachable attachment is selected from a group consisting of an adhesive and a hanging attachment.

In still another aspect the delivery device is delivered to the recipient by a representative of the public establishment.

In yet another aspect, the social communication device is selected from a group consisting of a label, a tag, a sculpture, a machine, a figure, a card, and an object.

In a further aspect, the message is selected from a group consisting of a written message, an auditory message, a visual message, a scented message, and a flavored message.

In still another aspect, the delivery device is selected from a group consisting of a smoking device, a drinking device, a contraceptive, a gelatin shot, and a food container.

In another aspect, the drinking device is selected from a group consisting of a bottle, a glass, and a novelty shot glass.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a flowchart illustrating the acts involved in a method of facilitating social communication according to the present invention;

FIGS. 2(a) through 2(e) are illustrations of an exemplary application of the acts of the invention, specifically showing the use of the invention in the context of a social meeting place such as a restaurant or bar;

FIGS. 3(a) through 3(c) are illustrations of examples of mechanisms through which a social communication device may be distributed;

FIGS. 4(a) through 4(c) are illustrations of two non-limiting examples of labels for use in conjunction with the present invention, with different patterns of application of adhesive material;

FIGS. 5(a) through 5(c) are illustrations of various examples of social communication devices that may be attached with a delivery device;

FIGS. 6(a) through 6(d) are illustrations of examples of a message in accordance with the present invention;

FIGS. 7(a) and 7(b) are illustrations of exemplary and non-limiting embodiments for attaching a social communication device to a delivery device;

FIGS. 8(a) through 8(d) are illustrations of exemplary delivery devices for use in conjunction of the present invention; and

FIGS. 9(a) through 9(c) illustrate exemplary placements of social communication devices on various delivery devices.

### DESCRIPTION

The present invention relates to the field of interpersonal communication. The following description is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is intended to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first an introduction is provided to provide the reader with a general understanding of the present invention. Next, a description of various aspects of the present invention is provided to give an understanding of the specific details.

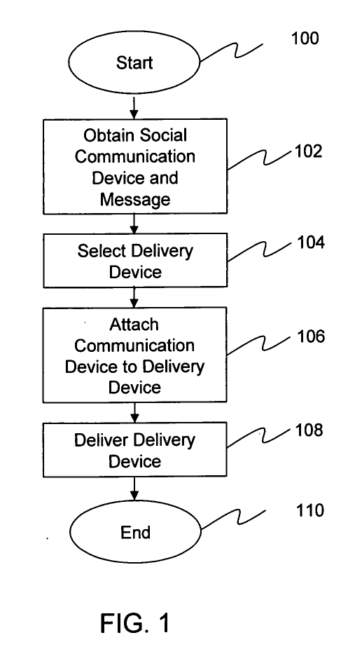

A flowchart of a method of interpersonal communication is presented in FIG. 1. As the method starts 100, a decision to communicate using a personal message is made. Next, an act of obtaining both a social communication device and an affixed message 102 is performed. Subsequently, an act of selecting a delivery device 104 is performed. Once the social communication device and the message have been obtained, and the delivery device has been selected, an act of attaching the social communication device with the affixed message to the delivery device is performed 106. Subsequently, in an act of delivering 108, the delivery device is delivered to the intended recipient of the communication. At this point, the message is communicated and the method ends 110.

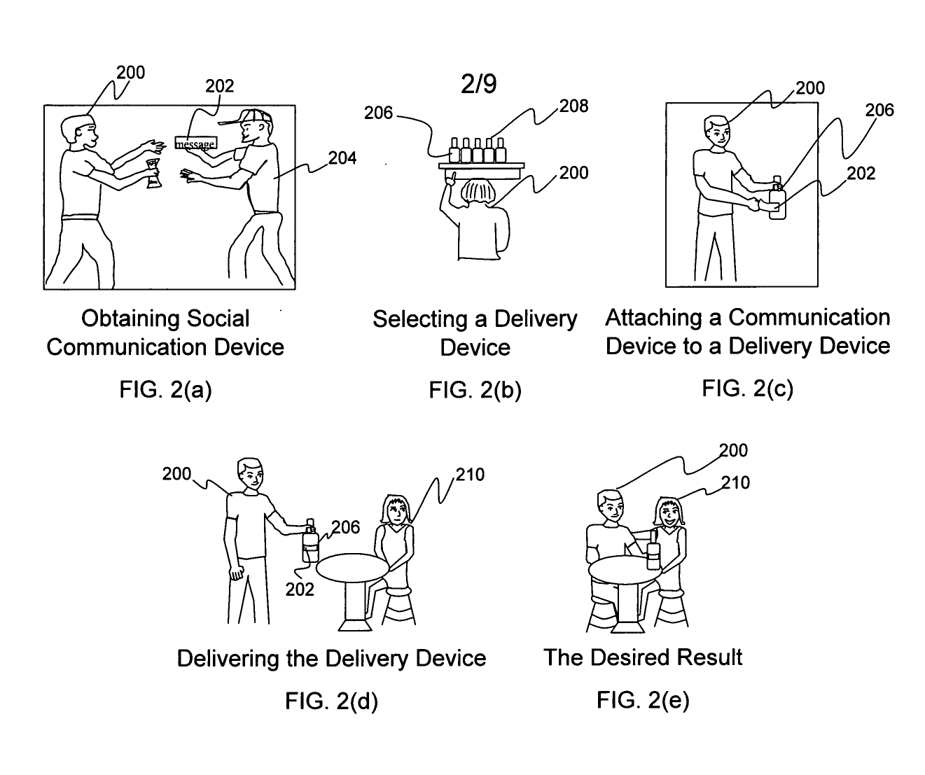

The method just described can be applied to many situations. To further clarify the acts of the method, a non-limiting example of a person using the method is illustrated in FIG. 2(a) through FIG. 2(e). The environment depicted is typical of a public establishment (such as a bar, a restaurant, or a nightclub), where the social communication device is obtained from the establishment (generally through a server acting on behalf of the establishment). The delivery device is in the form of a food/beverage item, also obtained from the establishment (again, generally through a server acting on behalf of the establishment). Either the user or the server may attach the social communication device to the delivery device, and either may deliver the delivery device to the recipient. Below, this scenario is described in greater detail.

FIG. 2(a) illustrates a person 200 obtaining a social communication device (e.g., an adhesive label) 202 from a vendor 204. In this non-limiting example, a message (e.g., writing) is pre-affixed with the social communication device 202. Next, as shown in FIG. 2(b), a person 200 selects a delivery device 206 (e.g., a beer bottle) from a display of bottle options 208. Subsequently, as shown in FIG. 2(c), the person 200 attaches the social communication device 202 with the pre-affixed message to the delivery device 206 using an adhesive. Then, as depicted in FIG. 2(d), the person 200 delivers the delivery device 206, with attached social communication device 202, to a recipient 210. FIG. 2(e) shows the person 200 and the recipient 210 having an enjoyable conversation as a result of the delivery of the delivery device 206. Note that although the message was shown as pre-affixed with the social communication device 202, the message may allow for customization (typically written) by the person, or may be randomly selected. Note further, that although the person 200 delivers the delivery device 206 directly to the recipient 210, such delivery may also be made through an intermediary (e.g., the vendor 204 may deliver the delivery device to the recipient 210 as an agent/representative or a machine may deliver the delivery device to the recipient 210).

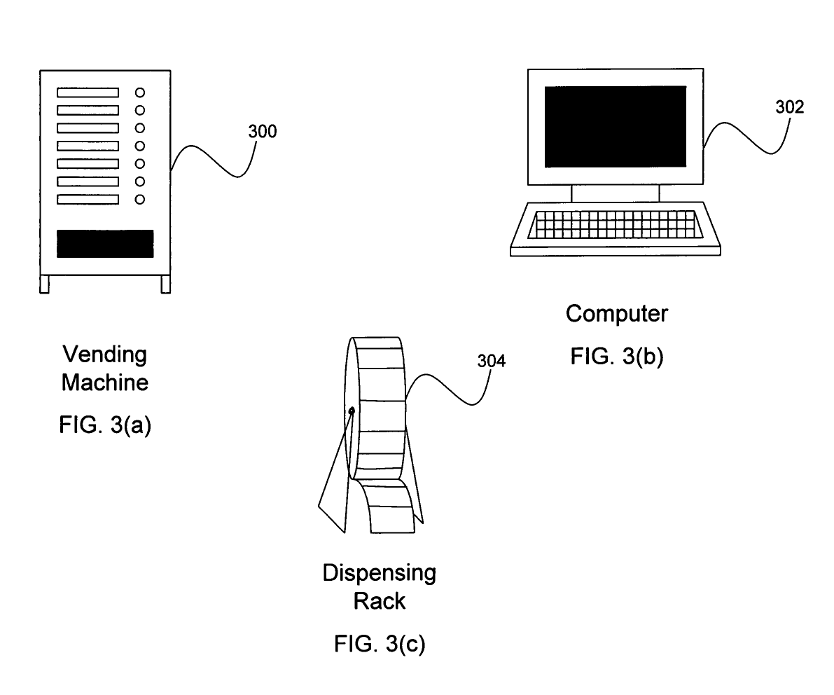

FIGS. 3(a) through 3(c) present non-limiting examples of mechanisms through which a social communication device may be distributed. FIG. 3(a) illustrates the vendor as a vending machine 300. FIG. 3(b) illustrates another alternative in which the vendor is a computer 302. In this case, the computer 302 could be used as an automated vending machine, installed in a restaurant/bar/club or it could exemplify a user's personal computer connected with the Internet, in which case, a variety of social communication device-types may simply be downloaded and printed for use (e.g., later at a party) via a user's computer. Still further, FIG. 3(c) shows another alternative in which the vendor is a dispensing rack 304. Note that although shown as a spool-type dispenser, the dispensing rack 304 could take many other forms, a non-limiting example of which is simply a box of labels with a dispensing portion thereon.

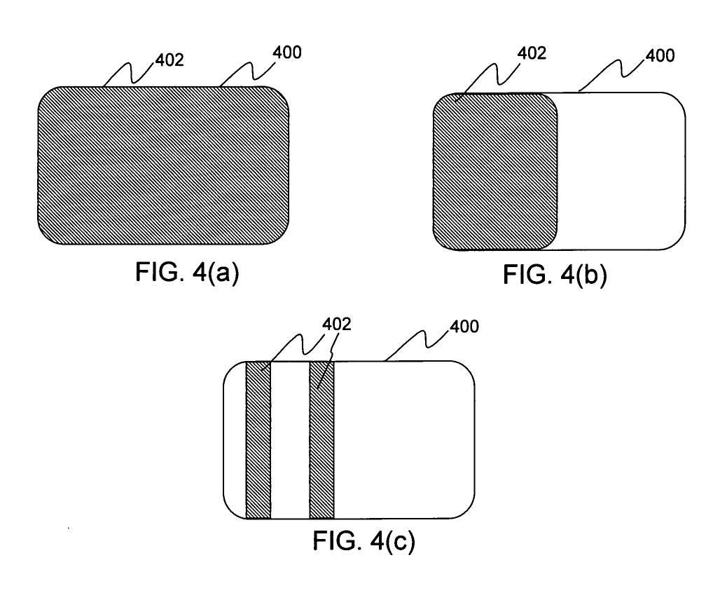

FIGS. 4(a) through 4(c) illustrate two non-limiting examples of labels with different patterns of application of adhesive material. Specifically, FIG. 4(a) presents an adhesive label 400 in which adhesive material 402 is distributed across the whole label. FIG. 4(b) presents another adhesive label 400 in which the adhesive material 402 is applied across approximately half of the label. Finally, FIG. 4(c) presents another adhesive label 400, where the adhesive material 402 is distributed in stripes on the back of the label, leaving part of the label with a non-adhesive surface.

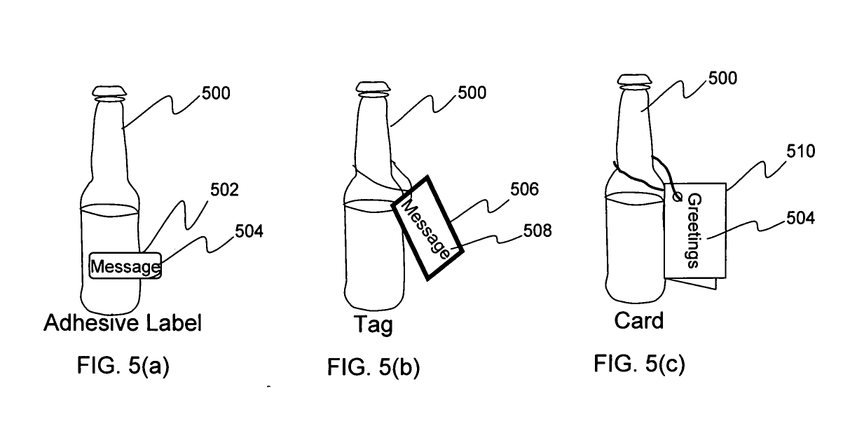

FIGS. 5(a) through 5(c) illustrate various non-limiting examples of a delivery device 500 with attached social communication devices and affixed messages. FIG. 5(a) shows an example of a delivery device 500 having a social communication device in the form of an adhesive label 502 with a message 504. As shown, the adhesive label 502 is attached directly to the delivery device 500. In this example, the message 504 is printed on the adhesive label 502. FIG. 5(b) illustrates an alternate example of a delivery device 500 with a social communication device in the form of a tag 506 with a printed message 508. FIG. 5(c) illustrates still another example of the social communication device, a card 510. In this example, a message 504 is printed on the card 514. Although a few examples of social communication devices were shown in FIG. 5(a) through 5(c), any suitable object may be used, and the present invention is not intended to be limited to the examples shown. Note that FIG. 5(b) through 5(c) show hanging-type methods of attaching the social communication device to the delivery device 500. Other methods of attachment may easily be envisioned, non-limiting examples of which include by hook-and-loop-type bindings (Velcro™), magnets, etc.

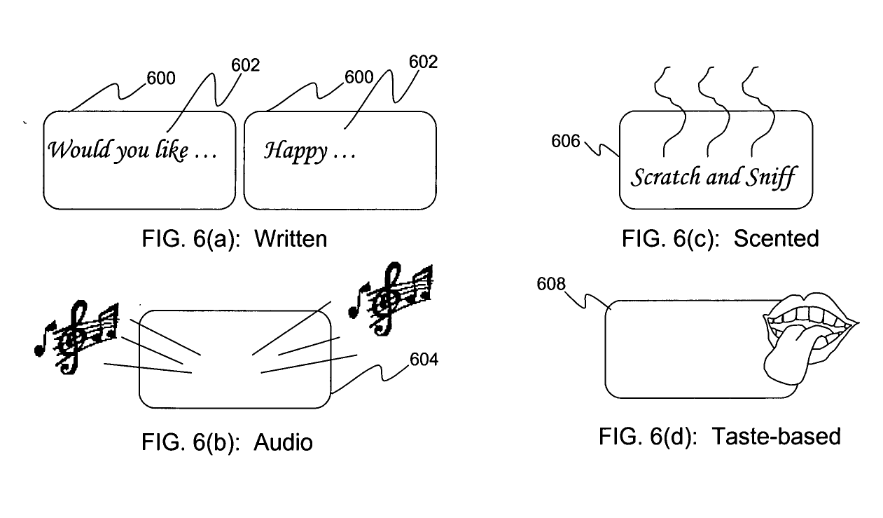

FIGS. 6(a) through 6(d) are illustrations of non-limiting examples of a message in accordance with the present invention. FIG. 6(a) shows two examples of stickers 600 according to the present invention, where the message thereon is in the form of a written message 602. This written message 602 may be preprinted in whole or in part, so that a purchaser can add content of his or her choosing. FIG. 6(b) presents another example, wherein the social communication device 202, again in the form of a sticker 600, emits an auditory message 604 (e.g., an audio recording). Recordings such as a song, a phrase, a poem, or a sound effect, may be either prerecorded or recorded by the purchaser before delivery. Further, FIG. 6(c) illustrates a scented message 606. Non-limiting examples of scented messages 606 include scents that are continually released and those that are released following an action by a user (i.e., scratch-and-sniff). FIG. 6(d) illustrates a taste-based (flavored) message 608 (e.g., a flavored sticker or candy). The messages illustrated in FIGS. 6(a) through 6(d) may be combined to create more complex messages.

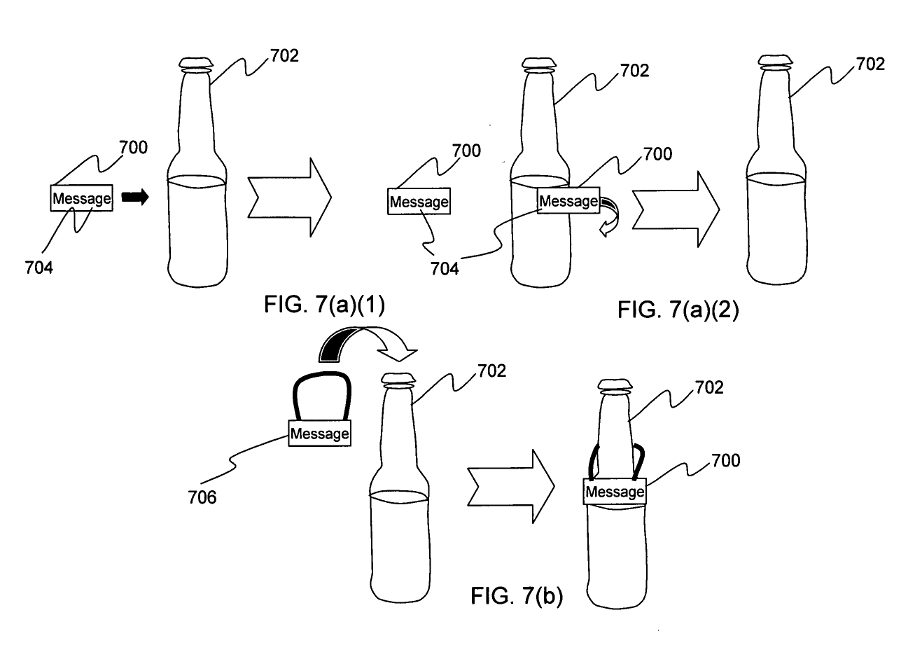

FIGS. 7(a) and 7(b) illustrate exemplary and non-limiting embodiments for attaching a social communication device 700 with a delivery device 702. FIG. 7(a)(1) illustrates the process of attaching a social communication device 700 with a delivery device 702 by adhesion. Here, a social communication device 700, in the form of a preprinted message, is depicted as attached with a delivery device 702 in the form of a bottle. FIG. 7(a)(2) illustrates the process of removing a social communication device 700 from a delivery device 702. In this case, where the social communication device 700 is in the form of a sticker and the delivery device 702 is in the form of a beverage container, the user simply peels the sticker off the beverage container. The social communication device 700 may also be removed from the delivery device 702 by dissolving it in water or some other adhesive-dissolving solution. FIG. 7(b) illustrates the process of attaching a social communication device 700 to a delivery device 702, where the social communication device 700 is in the form of a tag hung over a portion of the delivery device 702.

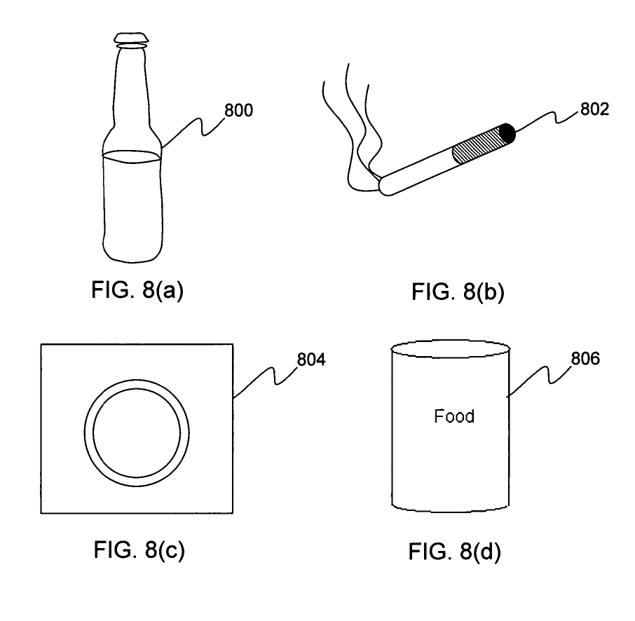

FIGS. 8(a) through 8(d) illustrate exemplary embodiments of a delivery device 206. A non-limiting example of a delivery device 206 that may be used is a drinking device 800 such as the bottle shown in FIG. 8(a). Other non-limiting examples of delivery devices 808 include a smoking device 802 such as a cigarette or a cigar, as illustrated in FIG. 8(b); a contraceptive device 804, as illustrated in FIG. 8(c); and a food container 806 such as a can, as illustrated in FIG. 8(d). It will be appreciated by one of skill in the art that this is an extremely limited set of examples, and that many other items may be used as delivery devices 206 (e.g., gelatin shots, ice cream cones, candy, novelty shot glasses (e.g., in the shape of test tubes), shot glasses, and many others). Delivery devices 206 may be obtained from a delivery device source such as a person, a machine (such as a vending machine), the Internet (by ordering online for later use at a party), from a display such as an in-store display, and from a retail store.

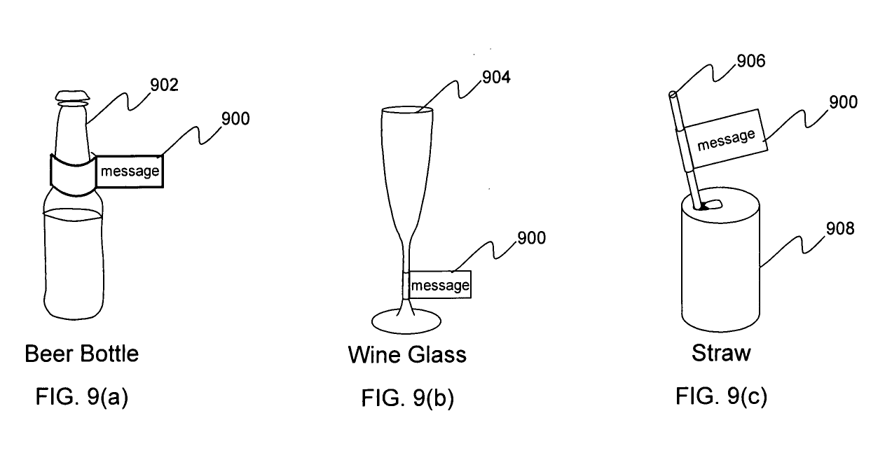

FIGS. 9(a) through 9(c) illustrate exemplary placements of social communication devices 202 on various delivery devices 206. In FIG. 9(a), a social communication device 202 in the form of a sticker 900 is attached with a neck of a beer bottle 902. In FIG. 9(b), a social communication device 202 in the form of a sticker 900 is attached with a stem of a wine glass 904. In FIG. 9(c), a social communication device 202 in the form of a sticker 900 is attached with a straw 906, where the straw 906 is placed in the mouth of a beverage can 908. In all of these cases, it is desirable that the social communication device 202 be placed on the delivery device 206 in a manner that makes it readily visible to a recipient.

What is claimed is:

1. A method of facilitating social communication from a person to a recipient, the method comprising of:
obtaining a social communication device having at least one message;
selecting a delivery device;
attaching the social communication device with the delivery device; and delivering the delivery device to the recipient; and
whereby, social communication is facilitated between people.

2. A method for facilitating social communication as set forth in claim 1, wherein:
the message is selected by the person, from a group consisting of a pre-existing message, a randomly generated message, and a customizable message and when:
the message includes a customizable message, customizing the message.

3. A method for facilitating social communication as set forth in claim 2, where in the act of obtaining the social communication device is obtained from a vendor.

4. A method for facilitating social communication as set forth in claim 3, where in the vendor is selected from a group consisting of a person, a vending machine, the Internet, a display, a computer, and a dispensing rack.

5. A method for facilitating social communication as set forth in claim 2, where in the act of selecting a delivery device is obtained from a delivery device source.

6. A method for facilitating social communication as set forth in claim 5, where in the delivery device is selected from a group consisting of a person, a machine, the Internet, a display, and a store.

7. A method for facilitating social communication as set forth in claim 2, where in the act of attaching the social communication device with the delivery device, the act of attaching is performed with a mechanism selected from a group consisting of a detachable attachment and a permanent adhesive.

8. A method for facilitating social communication as set forth in claim 7, where in when the mechanism is a detachable attachment, the detachable attachment is selected from a group consisting of an adhesive and a hanging attachment.

9. A method for facilitating social communication as set forth in claim 2, where in the act of delivering the delivery device is delivered to the recipient by a deliverer.

10. A method for facilitating social communication as set forth in claim 9, where in the act of delivering the deliverer is selected from a group consisting of the person, an agent/representative, and a machine.

11. A method for facilitating social communication as set forth in claim 2, where in the social communication device is selected from a group consisting of a label, a tag, a sculpture, a machine, a figure, a card, and an object.

12. A method for facilitating social communication as set forth in claim 2, where in the message is selected from a group consisting of a written message, an auditory message, a visual message, a scented message, and a flavored message.

13. A method for facilitating social communication as set forth in claim 2, where in the delivery device is selected from a group consisting of a smoking device, a drinking device, a contraceptive, a gelatin shot, and a food container.

14. A method for facilitating social communication as set forth in claim 13, where in the drinking device is selected from a group consisting of a bottle, a glass, and a novelty shot glass.

15. A method of facilitating social communication between a person and a recipient in a public establishment, the method comprising of:
obtaining a social communication device from the public establishment, where the social communication device has at least one message;
ordering a food/beverage item from the public establishment, where the food/beverage item acts as a delivery device;
attaching the social communication device with the delivery device; and delivering the delivery device to the recipient; and
whereby, social communication is facilitated between people.

16. A method for facilitating social communication between a person and a recipient in a public establishment as set forth in claim 15, wherein:
the message is selected by the person, from a group consisting of a pre-existing message, a randomly generated message, and a customizable message and when:
the message includes a customizable message, customizing the message.

17. A method for facilitating social communication between a person and a recipient in a public establishment as set forth in claim 16, where in the act of obtaining the social communication device is obtained from a server acting on behalf of the public establishment.

18. A method for facilitating social communication between a person and a recipient in a public establishment as set forth in claim 17, where in the public establishment is selected from a group consisting of a bar, a restaurant, and a nightclub.

19. A method for facilitating social communication between a person and a recipient in a public establishment as set forth in claim 16, where in the act of selecting a delivery device is obtained from a delivery device source.

20. A method for facilitating social communication between a person and a recipient in a public establishment as set forth in claim 16, where in the act of attaching the social communication device with the delivery device, the act of attaching is performed with a mechanism selected from a group consisting of a detachable attachment and a permanent adhesive.

21. A method for facilitating social communication between a person and a recipient in a public establishment as set forth in claim 20, where in when the mechanism is a detachable attachment, the detachable attachment is selected from a group consisting of an adhesive and a hanging attachment.

22. A method for facilitating social communication between a person and a recipient in a public establishment as set forth in claim 16, where in the act of delivering the delivery device is delivered to the recipient by a representative of the public establishment.

23. A method for facilitating social communication between a person and a recipient in a public establishment as set forth in claim 16, where in the social communication device is selected from a group consisting of a label, a tag, a sculpture, a machine, a figure, a card, and an object.

24. A method for facilitating social communication between a person and a recipient in a public establishment as set forth in claim 16, where in the message is selected from a group consisting of a written message, an auditory message, a visual message, a scented message, and a flavored message.

25. A method for facilitating social communication between a person and a recipient in a public establishment as set forth in claim 16, where in the delivery device is selected from a group consisting of a smoking device, a drinking device, a contraceptive, a gelatin shot, and a food container.

26. A method for facilitating social communication between a person and a recipient in a public establishment as set forth in claim 16, where in the drinking device is selected from a group consisting of a bottle, a glass, and a novelty shot glass.
